(19) United States
(12) Patent Application Publication
(10) Pub. No.: US 2011/0134717 A1
(43) Pub. Date: Jun. 9, 2011

(54) METHOD AND DEVICE FOR PRODUCING A COATING MATERIAL

(75) Inventors: Hisashi Furuichi, Osaka (JP); Tsumoru Ohata, Osaka (JP)

(73) Assignee: PRIMIX CORPORATION, Osaka-shi, Osaka (JP)

(21) Appl. No.: 13/057,117

(22) PCT Filed: Aug. 5, 2009
(86) PCT No.: PCT/JP2009/063853

§ 371 Date: Feb. 1, 2011

(30) Foreign Application Priority Data
Aug. 11, 2008 (JP) 2008-206851

(51) Int. Cl. B01F 13/06

(52) U.S. Cl. 366/139

(57) ABSTRACT

A method for producing a coating material in which ingredients including a powder and a solvent are mixed is provided. The method includes: a preliminary stirring step (100) of preliminarily stirring the ingredients; a high-speed stirring step of supplying an intermediate material obtained by the preliminary stirring step to a high-speed stirrer 300 including a container 310 and a rotational member 330 rotating at a high speed slightly inward of an inner wall surface 311 of the container, and continuously stirring the intermediate material caused to exist in the form of a film between the rotational member 330 and the inner wall surface 311 by a centrifugal force of the rotational member 330; and a vacuum defoaming step of supplying a stirred material obtained by the high-speed stirring step to a treatment tank 501, 502, 503 provided with a stirring blade to perform vacuum defoaming.

### TECHNICAL FIELD

The present invention relates to a method and an apparatus for producing coating materials, including an electrode material for a battery.

### BACKGROUND ART

The demand for batteries such as lithium-ion secondary batteries is expected to increase further in the future, for use as a power source of portable electronic devices or electric cars, and storage of electric power generated by wind or solar power generation facility, for example. As for these batteries, reduction in size and weight as well as enhanced safety is demanded. For instance, in using lithium-ion batteries as the power source of an electric car, a plurality of batteries are used as connected in series. If even one of these batteries has an electrode defect, the risk of firing increases. On the other hand, to provide a smaller battery with a larger capacity, the electrode film needs to be made thinner.

To realize the thickness reduction of a battery while securing safety, it is necessary to apply an electrode coating material onto an electrode base material thinly and uniformly over the entire surface of the electrode base material, which, however, is extremely difficult. If the electrode coating material applied onto the electrode base material is not uniform or includes aggregates scattered over the material, a defect in the electrode occurs, causing significant deterioration of safety.

Generally, in a conventional method of producing an electrode coating material of a secondary battery, ingredients are put into a container by a batch process and stirred for dispersion by rotating a stirring blade, as proposed in e.g. Patent Document 1.

However, since the above-described electrode coating material production method employs a batch process for stirring the material, perfectly uniform stirring is not assured. Thus, non-dispersed matter (aggregated matter) may be generated from the material adhering to the container or the material remaining unstirred adjacent to the shaft of the stirring blade. Moreover, when the stirring step is repeated without cleaning the container, the amount of the material built up particularly on the shaft driving portion of the stirring blade in an upper portion of the container or the inner surface of the container increases, and this may mix, as aggregated matter, into the coating material. Further, since the dispersion is not satisfactory, aggregation often occurs in the once dispersed material.

Conventionally, therefore, such non-dispersed matter or aggregates in the coating material obtained by completing the above-described stirring step is usually removed with a filter. However, aggregates smaller than a certain particle size cannot be reliably removed even with a filter. In a coating step in which the coating material prepared in this way is supplied to a die nozzle and applied onto a base electrode material, the aggregates may be jammed between the die nozzle and the base electrode material, causing an application failure such as the formation of a linear coating pattern or dispersion of the aggregates over the coating surface.

To enhance the performance of a secondary battery, the particle size of the electrode material needs to be reduced. However, in the conventional method in which the filtering step for removing the aggregates from the coating material is essential, the removal of aggregates or the like using a filter with a smaller mesh takes long time, resulting in considerable deterioration of production efficiency.

Thus, the conventional method for producing an electrode coating material is not satisfactory, in terms of efficiently producing an electrode coating material capable of achieving reduction in the electrode film thickness while maintaining high safety.

### PRIOR ART

### Patent Document

Patent Document 1: JP-A-2004-199916

### DISCLOSURE OF THE INVENTION

### Problem to be Solved by the Invention

The present invention has been proposed under the circumstances described above. It is therefore an object of the present invention to provide a method and an apparatus which are capable of eliminating or simplifying the step of removing aggregates or the like and efficiently producing a coating material that can be applied thinly and uniformly onto a target surface.

### Means for Solving the Problem

To solve the above-described problem, the present invention takes the following technical means.

According to a first aspect of the present invention, there is provided a method for producing a coating material of mixed ingredients including a powder and a solvent. The method comprises: a preliminary stirring step of preliminarily stirring the ingredients; a high-speed stirring step of continuously stirring an intermediate material obtained by the preliminary stirring step in a high-speed stirrer including a container and a rotational member rotating at a high speed slightly inward of an inner wall surface of the container, wherein the intermediate material is caused to exist in the form of a film between the rotational member and the inner wall surface by a centrifugal force of the rotational member; and a vacuum defoaming step of vacuum-defoaming a stirred material obtained by the high-speed stirring step in a treatment tank provided with a stirring blade.

Preferably, the preliminary stirring step comprises loading the ingredients into a preliminary stirring tank provided with a stirring blade for performing stirring, introducing the intermediate material obtained by the stirring in the preliminary stirring tank into a storage tank provided with a stirring blade, and continuously supplying the intermediate material from the storage tank to the high-speed stirrer for the high-speed stirring step.

Preferably, the stirred material discharged from the high-speed stirrer is once introduced into a buffer tank and then transferred from the buffer tank to the treatment tank for the vacuum defoaming step.

Preferably, the vacuum defoaming step is performed using a plurality of treatment tanks each having a temperature adjustment function, and the stirred material from the buffer tank is successively supplied selectively to the treatment tanks.

Preferably, the material after vacuum-de foamed is successively transferred selectively from the treatment tanks to a coating step.

According to a second aspect of the present invention, there is provided an apparatus for producing a coating material of mixed ingredients including a powder and a solvent. The apparatus comprises: a preliminary stirring tank for loading the ingredients and preliminary stirring the ingredients; a high-speed stirrer for receiving an intermediate material obtained by the preliminary stirring by the preliminary stirring tank, the high-speed stirrer including a container and a rotational member rotating at a high speed slightly inward of an inner wall surface of the container, to continuously stir the intermediate material caused to exist in the form of a film between the rotational member and the inner wall surface by a centrifugal force of the rotational member; a treatment tank for receiving a stirred material provided by the high-speed stirrer and vacuum-defoaming the stirred material while stirring with a stirring blade, and a transferer for transferring the material after vacuum-defoamed by the treatment tank to a coating step as a coating material.

Preferably, the apparatus further comprises a storage tank provided with a stirring blade for receiving the intermediate material obtained by the preliminary stirring by the preliminary stirring tank and continuously supplying the intermediate material to the high-speed stirrer.

Preferably, the apparatus further comprises a buffer tank for receiving the stirred material discharged from the high-speed stirrer and transferring the stirred material to the treatment tank.

Preferably, a pipe for supplying the stirred material, discharged from the high-speed stirrer, to the buffer tank is surrounded by a path for a cooling medium.

Preferably, the treatment tank comprises a plurality of treatment tanks each surrounded by a path for a temperature adjusting medium, into which the stirred material is successively supplied selectively.

Preferably, the transferer successively transfers the material after vacuum-defoamed selectively from the treatment tanks to the coating step.

Preferably, the rotational member of the high-speed stirrer is in the form of a cylinder arranged with a small gap between itself and the inner wall surface of the container and includes a plurality of holes penetrating in an inward-outward direction.

Preferably, the rotational member or the inner wall surface of the container is partially or entirely made of a wear resistant material.

Preferably, the coating material production method according to the first aspect of the present invention and the coating material production method according to the second aspect of the present invention are applied to the production of an electrode material for a lithium-ion secondary battery or capacitor.

Other features and advantages of the present invention will become more apparent from the detailed description given below with reference to the accompanying drawings.

### BRIEF DESCRIPTION OF THE DRAWINGS

FIG. 1 is an overall structural view of a coating material production apparatus according to the present invention;

FIG. 2 is a sectional view showing an example of high-speed stirrer of the apparatus shown in FIG. 1; and

FIG. 3 illustrates coating of an object using a die nozzle.

### BEST MODE FOR CARRYING OUT THE INVENTION

Preferred embodiments of the present invention are described below with reference to the accompanying drawings.

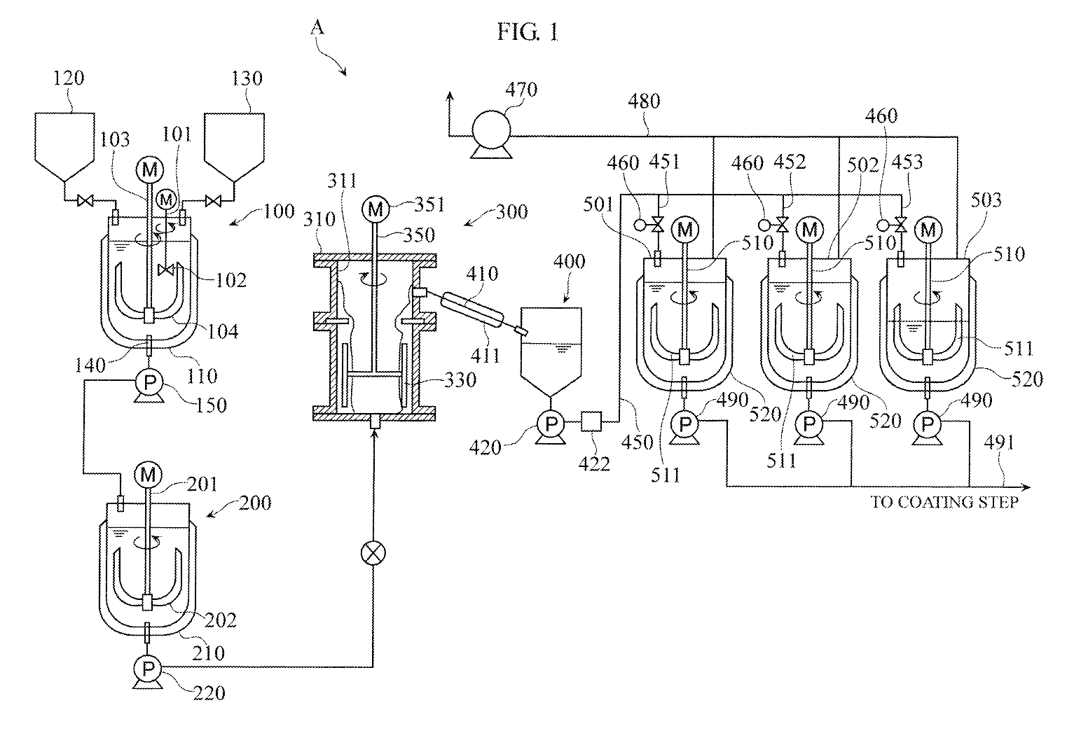

FIG. 1 shows an overall structure of an apparatus A for producing a coating material according to an embodiment of the present invention. The production apparatus A includes a preliminary stirring tank 100, a storage tank 200, a high-speed stirrer 300, a buffer tank 400, and a plurality of treatment tanks 501, 502 and 503.

The preliminary stirring tank 100 is provided to mix ingredients to some degree, prior to substantial stirring in the high-speed stirrer 300. In this embodiment, the preliminary stirring tank includes a smaller-diameter stirring blade 102 that rotates at a higher speed about a vertical rotation shaft 101 and a larger-diameter stirring blade 104 that rotates at a lower speed about a vertical rotation shaft 103. Ingredients from ingredient hoppers 120 and 130 are collected in the preliminary stirring tank and preliminarily stirred by rotating the two stirring blades 102 and 104. The high-speed rotation of the smaller-diameter stirring blade 102 mixes the ingredients, while the rotation of the larger-diameter stirring blade 104 stirs the entire material to provide a uniformly mixed state. In this embodiment, the preliminary stirring tank 100 is surrounded by a jacket 110 through which a temperature adjusting medium can flow, so that the temperature during the preliminary stirring is appropriately adjustable.

Examples of the ingredients to be fed into the preliminary stirring tank 100 include a powder as an active material appropriate for forming an electrode material for a lithium-ion secondary battery, a solvent and a binder. Examples of a positive-electrode active material include a powder of lithium cobalt oxide, lithium nickel oxide, lithium manganese oxide, lithium iron phosphate, and combination or modification of these. Examples of a negative-electrode active material include a powder of natural graphite, synthetic graphite, silicon-based compounds or alloy materials.

The stirring in the preliminary stirring tank 100 is performed by a batch process. When each time of stirring is finished, the intermediate material in the form of slurry obtained by the stirring is transferred from a discharge port 140 at the bottom of the preliminary stirring tank 100 to the storage tank 200 via a pump 150.

The storage tank 200 includes a stirring blade 202 having a large diameter and constantly rotating at a low speed about a vertical rotation shaft 201, so that the intermediate slurry material is stirred slowly in the storage tank. In this embodiment, the storage tank 200 is also surrounded by a jacket 210 through which a temperature adjusting medium can flow, so that the temperature of the intermediate material is appropriately adjustable. The intermediate material discharged from the bottom of the storage tank 200 is continuously transferred to the high-speed stirrer 300 via a pump 220. That is, the storage tank 200 enables the intermediate material to be continuously transferred to the high-speed stirrer 300, in spite of the fact that stirring in the preliminary stirring tank 100 is performed by a batch process. Since the storage tank 200 is provided with the stirring blade 202 as noted above, intermediate material (slurry) in the same condition can be transferred to the high-speed stirrer 300, although the powder in the intermediate material is not yet highly dispersed and aggregation can occur.

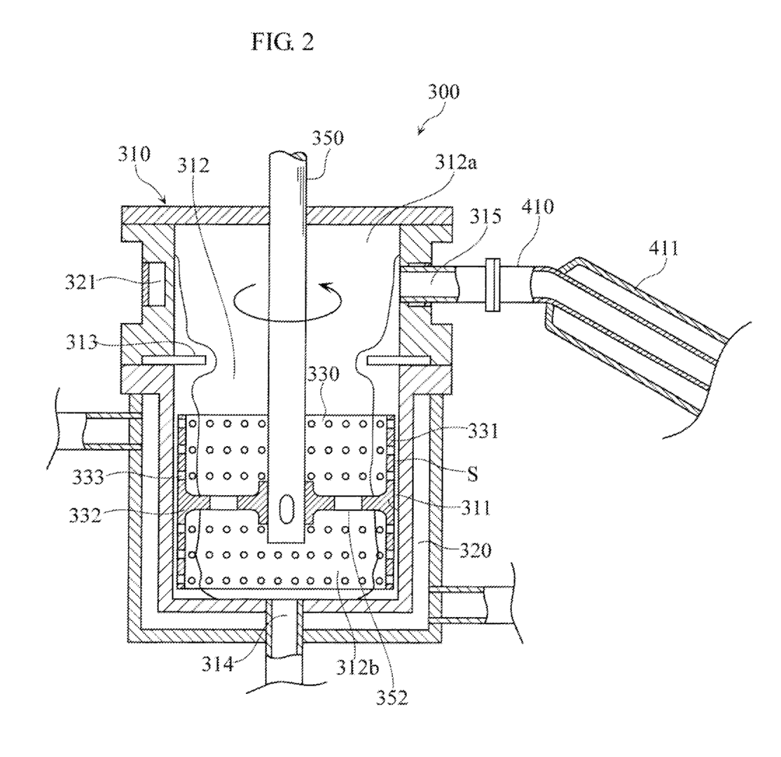

As specifically shown in FIG. 2, the high-speed stirrer 300 includes a container 310, and a rotational member 330 that rotates at a high speed about a rotation shaft 350 extending vertically at the center of the container 310.

The container 310 has a generally cylindrical inner wall surface 311, defining a cylindrical space 312 having a predetermined length in the vertical direction. The rotation shaft 350 is rotated at a high speed by a high torque motor 351 mounted above the container 310. The cylindrical space 312 is divided into an upper space 312a and a lower space 312b by an inward flange 313. A material supply port 314 connected to the lower space 312b is provided at the bottom of the container 310. The intermediate material in the form of slurry transferred from the storage tank 200 is supplied from the material supply port 314. A discharge port 315 connected to the upper space 312a is provided at an upper portion of the container 310, through which the slurry material after being stirred is discharged to the outside. A jacket 320 through which cooling water can circulate is provided around the lower space 312b of the container 310, whereas a cooling water circulation path 321 is provided around the upper space 312a.

The rotational member 330 comprises a cylindrical member 332 having an outer circumferential surface 331 facing the inner wall surface 311 via a small gap S of about 1 to 3 mm in the lower space 312b and is supported on the rotation shaft 350 via a support member 352. The cylindrical member 332 is formed with a plurality of holes 333 penetrating in the inward-outward direction.

It is desirable that at least the cylindrical member 332 of the rotational member 330 is made of a material with a high resistance to wear, such as fine ceramic material, or the outer circumferential surface 331 of the cylindrical member 332 is coated with a material with a high resistance to wear, such as fine ceramic material. Also, it is desirable that, of the inner wall surface 311 of the container 310, at least the region facing the rotational member 330 via the gap S is coated with a material with a high resistance to wear, such as fine ceramic material. Examples of such fine ceramic material include alumina ceramic material.

The rotational member 330 is rotated at a high speed in such a manner that the peripheral speed of the rotational member 330 (speed relative to the inner wall surface 311) is 10 to 50 m/s. As will be described later, a motor with a high torque and a high output is necessary for rotating the rotational member 330 at such a peripheral speed while performing stirring, and the dimensions of the container 310 and the rotational member 330 are selected in accordance with a usable motor. At a given peripheral speed of the rotational member 330, the processing ability of the high-speed stirrer 300 is substantially proportional to the area of the outer circumferential surface 331 of the rotational member 330. Thus, the processing ability can be enhanced by increasing the radius of the container 310 and rotational member 330.

When supplied to the high-speed stirrer 300, the intermediate material in the form of slurry receives a centrifugal force by the rotational member 330 rotating at a high speed and is hence pressed against the inner wall surface 311 of the container 310. The intermediate material is continuously introduced to spread in the gap S between the outer circumferential surface 331 of the cylindrical member 332 of the rotational member 330 and the inner wall surface 311 of the container 310. Since the cylindrical member 332 of this embodiment is formed with a plurality of holes 333, the intermediate material coming into contact with the inner surface of the cylindrical member 332 is also smoothly guided into the gap S. As noted before, the cylindrical member 332 has a high peripheral speed of e.g. 10 to 50 m/s. When the peripheral speed is 20 m/s, the intermediate material existing between the outer circumferential surface 331 of the cylindrical member 332 and the inner wall surface 311 of the container 310 is subjected to a sharp velocity gradient of 0 to 20 m/s within a small thickness of 1 to 3 mm. Thus, the intermediate slurry material continues to receive a strong shearing force, and the strong energy provides considerably high level of powder dispersion. Conceivably, this is because a phenomenon similar to a sudden turbulence transition occurs continuously due to the action of the very strong shearing energy, in spite of the fact that the intermediate material in the form of slurry has a relatively high viscosity.

The intermediate material is continuously fed into the high-speed stirrer 300 and constantly receives a centrifugal force due to the high-speed rotation of the rotational member 330. Thus, the stirred material climbs on the inner wall surface 311 of the container 310 beyond the inward flange 313 and is eventually discharged continuously from the discharge port 315 of the upper space 312a.

During the operation of the high-speed stirrer 300, the intermediate material, subjected to stirring due to the strong shearing energy between the rotational member 330 and the inner wall surface 311, heats up due to the heat generated by friction. However, the intermediate material is properly cooled by the cooling water flowing through the cooling water circulation jacket 320 and the cooling water circulation path 321, so that boiling or the like of the intermediate material is prevented.

As noted before, the outer circumferential surface 331 of the rotational member 330 and the inner wall surface 311 of the container 310 may be coated with a material with a high resistance to wear, such as fine ceramic material. With this arrangement, minute foreign matter such as wear metal particles, generated by the intermediate material's reception of a strong shearing force between these surfaces, is effectively prevented from mixing into the intermediate slurry material.

The slurry material stirred by the high-speed stirrer 300 is introduced into the buffer tank 400 via a conduit 410 due to the action of gravity. In this embodiment, the conduit 410 is also provided with a cooling water circulation path 411 in the form of a double tube, which, in combination with the cooling effect by the cooling water circulation jacket 320 and the cooling water circulation path 321 of the high-speed stirrer 300, properly cools the material after the stirring.

The slurry material after passing through the buffer tank 400 is supplied successively, via a pump 420, to each of the three vacuum-defoaming treatment tanks 501, 502 and 503 arranged in a row. The feed pipe 450 from the pump 420 to each of the treatment tanks 501, 502 and 503 is provided with a filter 422 for removing foreign matter accidentally mixed in the material. The feed pipe 450 includes branch pipes 451, 452 and 453 for treatment tanks 501, 502, and 503, respectively, which are provided with valves 460 controlled by a controller, not shown, to be opened or closed. A pipe 480 for applying vacuum generated by e.g. a vacuum pump 470 is also connected to each of the treatment tanks 501, 502 and 503.

Each of the treatment tanks 501, 502 and 503 is provided with a stirring blade 511 that rotates at a low speed about a vertical rotation shaft 510, so that to the slurry material introduced in the tank can be stirred slowly. Each of the treatment tanks 501, 502 and 503 is surrounded by a jacket 520 through which a temperature adjusting medium circulates. Each of the treatment tanks 501, 502 and 503 may have the same structure as that of the storage tank 200 except that vacuum application is made possible with respect to the treatment tanks.

With a predetermined amount of slurry material supplied, each of the treatment tanks 501, 502 and 503 rotates the stirring blade 511 while applying vacuum, thereby performing vacuum defoaming of the material by a batch process. After the vacuum defoaming is completed, the defoamed slurry material is supplied from the treatment tanks 501, 502 and 503 to a coating step via a pump 490 and a conduit 491. The defoaming step is performed successively, by supplying slurry material from the buffer tank 400 to the treatment tanks 501, 502 and 503 emptied by discharging all the defoamed slurry material to the coating step. In this way, although the vacuum defoaming step in each of the treatment tanks 501, 502 and 503 is performed by a batch process, material from the buffer tank 400 can be continuously supplied, and the defoamed slurry material can be continuously supplied to the coating step. The provision of the jacket 520 for the circulation of a temperature adjusting medium around each of the treatment tanks 501, 502 and 503 allows adjustment of the viscosity of the defoamed slurry material and promotes defoaming. The successive supply of slurry material to each of the treatment tanks 501, 502 and 503 and the continuous supply of defoamed slurry material from each of the treatment tanks 501, 502 and 503 to the coating step can be controlled by controlling the opening/closing of the valves 460 provided at the material-feeding branch pipes 451, 452, 453 and the on/off state of the pump 490 provided at each of the treatment tanks 501, 502 and 503.

In the coating material production apparatus A described above, a material including at least a powder and a solvent is first preliminarily stirred and then supplied to the high-speed stirrer 300 for substantial stirring. The above-described special effect by the high-speed stirrer 300 provides a slurry material in which powder is highly dispersed in the solvent. As noted before, when the apparatus is used for producing an electrode coating material for lithium-ion secondary batteries, it is desirable that the powder to be supplied as the active material has a particle size not larger than e.g. 20 μm. According to the coating material production apparatus A described above, owing to the stirring by the high-speed stirrer 300, the active material powder in the coating material does not aggregate even after the lapse of a long period of time from the treatment, and breaking of the powder particles into smaller particles is even observed.

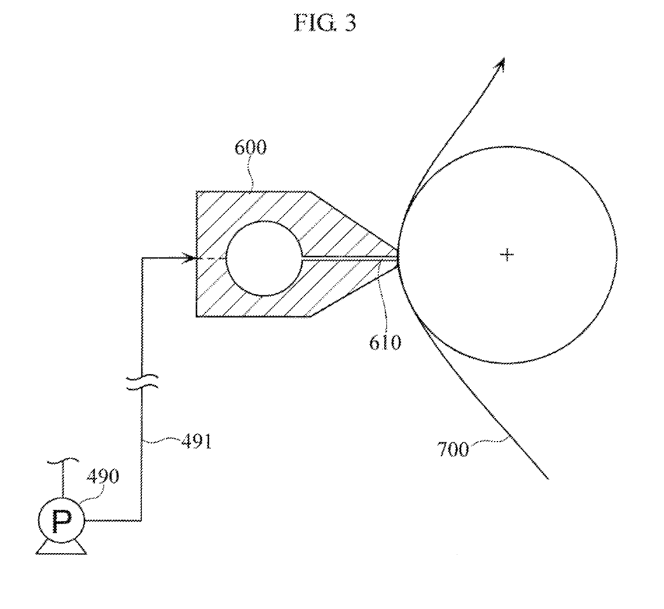

Moreover, in the coating material production apparatus A described above, since vacuum defoaming is performed with respect to the slurry material after stirred by the high-speed stirrer 300, the coating material produced does not contain aggregates of the active material nor does it contain bubbles. Therefore, in the case where the produced coating material is applied to the electrode base material 700 via a die nozzle 600 (FIG. 3), the coating material is smoothly fed even when the opening 610 of the die nozzle 600 is made considerably narrow. This allows formation of an extremely thin electrode material layer on the electrode base material 700. Moreover, a defect in the electrode material layer due to aggregates or bubbles hardly occurs. In this way, the present invention makes a large contribution to size reduction and safety enhancement in the field of battery production such as lithium-ion battery production.

The coating material production apparatus A described above achieves high efficiency in coating material production, because the high-speed stirrer 300 continuously performs high dispersion of powder in the solvent, and further, the plurality of treatment tanks 501, 502 and 503 allow continuous supply of the defoamed slurry material.

The scope of the invention is not limited to the foregoing embodiment. Any variations in the scope of matter set forth in each of the claims are to be included in the scope of the present invention.

Although the foregoing embodiment is to produce an electrode coating material for a lithium-ion secondary battery, the present invention is applicable to the production of an electrode coating material for other kinds of batteries or capacitors, and to any coating material obtained by mixing a powder and a solvent.

1. A method for producing a coating material of mixed ingredients including a powder and a solvent, the method comprising:
a preliminary stirring step of preliminarily stirring the ingredients;
a high-speed stirring step of continuously stirring an intermediate material obtained by the preliminary stirring step in a high-speed stirrer including a container and a rotational member rotating at a high speed slightly inward of an inner wall surface of the container, wherein the intermediate material is caused to exist in a form of a film between the rotational member and the inner wall surface by a centrifugal force of the rotational member; and
a vacuum defoaming step of vacuum-defoaming a stirred material obtained by the high-speed stirring step in a treatment tank provided with a stirring blade.

2. The method for producing a coating material according to claim 1, wherein the preliminary stirring step comprises loading the ingredients into a preliminary stirring tank provided with a stirring blade for performing stirring, introducing the intermediate material obtained by the stirring in the preliminary stirring tank into a storage tank provided with a stirring blade, and continuously supplying the intermediate material from the storage tank to the high-speed stirrer for the high-speed stirring step.

3. The method for producing a coating material according to claim 1, wherein the stirred material discharged from the high-speed stirrer is once introduced into a buffer tank and then transferred from the buffer tank to the treatment tank for the vacuum defoaming step.

4. The method for producing a coating material according to claim 3, wherein the vacuum defoaming step is performed using a plurality of treatment tanks each having a temperature adjustment function, and the stirred material from the buffer tank is successively supplied selectively to the treatment tanks.

5. The method for producing a coating material according to claim 4, wherein the material after vacuum-defoamed is successively transferred selectively from the treatment tanks to a coating step.

6. The method for producing a coating material according to claim 1, wherein the coating material is an electrode material for a lithium-ion secondary battery or capacitor.

7. An apparatus for producing a coating material of mixed ingredients including a powder and a solvent, the apparatus comprising:
a preliminary stirring tank for loading the ingredients and preliminary stirring the ingredients;
a high-speed stirrer for receiving an intermediate material obtained by the preliminary stirring by the preliminary stirring tank, the high-speed stirrer including a container and a rotational member rotating at a high speed slightly inward of an inner wall surface of the container, to continuously stir the intermediate material caused to exist in a form of a film between the rotational member and the inner wall surface by a centrifugal force of the rotational member;
a treatment tank for receiving a stirred material provided by the high-speed stirrer and vacuum-defoaming the stirred material while stirring with a stirring blade, and
a transferer for transferring the material after vacuum-defoamed by the treatment tank to a coating step as a coating material.

8. The apparatus for producing a coating material according to claim 7, further comprising a storage tank provided with a stirring blade for receiving the intermediate material obtained by the preliminary stirring by the preliminary stirring tank and continuously supplying the intermediate material to the high-speed stirrer.

9. The apparatus for producing a coating material according to claim 7, further comprising a buffer tank for receiving the stirred material discharged from the high-speed stirrer and transferring the stirred material to the treatment tank.

10. The apparatus for producing a coating material according to claim 9, wherein a pipe for supplying the stirred material, discharged from the high-speed stirrer, to the buffer tank is surrounded by a path for a cooling medium.

11. The apparatus for producing a coating material according to claim 7, wherein the treatment tank comprises a plurality of treatment tanks each surrounded by a path for a temperature adjusting medium, into which the stirred material is successively supplied selectively.

12. The apparatus for producing a coating material according to claim 11, wherein the transferer successively transfers the material after vacuum-defoamed selectively from the treatment tanks to the coating step.

13. The apparatus for producing a coating material according to claim 7, wherein the rotational member of the high-speed stirrer is in a form of a cylinder arranged with a small gap between itself and the inner wall surface of the container and includes a plurality of holes penetrating in an inward-outward direction.

14. The apparatus for producing a coating material according to claim 13, wherein the rotational member or the inner wall surface of the container is partially or entirely made of a wear resistant material.

15. The apparatus for producing a coating material according to claim 7, wherein the coating material is an electrode material for a lithium-ion secondary battery or capacitor.
